(19) United States
(12) Patent Application Publication
(10) Pub. No.: US 2023/0108309 A1
(43) Pub. Date: Apr. 6, 2023

(54) METHODS AND SYSTEMS FOR GAS METER REPLACEMENT PROMPT BASED ON A SMART GAS INTERNET OF THINGS

(71) Applicant: CHENGDU QINCHUAN IOT TECHNOLOGY CO., LTD., Chengdu (CN)

(72) Inventors: Zehua SHAO, Chengdu (CN); Haitang XIANG, Chengdu (CN); Yaqiang QUAN, Chengdu (CN); Yong LI, Chengdu (CN); Xiaojun WEI, Chengdu (CN)

(73) Assignee: CHENGDU QINCHUAN IOT TECHNOLOGY CO., LTD., Chengdu (CN)

(21) Appl. No.: 18/050,474

(22) Filed: Oct. 28, 2022

(30) Foreign Application Priority Data
Sep. 27, 2022 (CN) 202211181479.4

(51) Int. Cl. G05B 23/02

(52) U.S. Cl. CPC G05B 23/0283; G05B 23/0243; G05B 23/0224

(57) ABSTRACT

The present disclosure provides a method for gas meter replacement prompt based on a smart gas Internet of Things and a system thereof. The method is applied to a sub platform of a management platform of a smart gas indoor device, wherein the method includes: obtaining model data, use data, and maintenance data of a target gas meter in a smart gas data center; determining a target time for replacing the target gas meter and uploading the target time to the smart gas data center based on the model data, use data and maintenance data of the target gas meter, wherein the smart gas data center is configured to send the target time to a smart gas service platform, and the smart gas service platform is configured to send the target time to a smart gas user platform.

### CROSS-REFERENCE TO RELATED APPLICATIONS

The present application claims priority to Chinese Patent Application No. CN202211181479.4, filed on Sep. 27, 2022, the contents of which are hereby incorporated by reference to its entirety.

### TECHNICAL FIELD

The present disclosure generally relates to smart gas meter, in particular, to a method and a system for gas meter replacement prompt based on a smart gas Internet of Things.

### BACKGROUND

According to national regulations, after the gas meter is installed and used, the use age of the gas meter using natural gas generally does not exceed 10 years; the use age of gas meters using artificial gas and liquefied petroleum gas as the medium generally does not exceed 6 years. The gas meters need to be replaced when the use age is expired. However, the above-mentioned maximum period may be a general provision, which sometimes does not suitable for individual actual situations; sometimes the user does not know that the gas meter should be replaced.

Therefore, it is necessary to propose a method and system for gas meter replacement prompt based on the smart gas Internet of Things, so as to quickly judge the necessity of gas meter replacement without going door-to-door.

### SUMMARY

One or more embodiments of the present disclosure provide a method for gas meter replacement prompt based on a smart gas Internet of Things, the method being applied to a sub platform of a management platform of a smart gas indoor device, wherein the method comprises: obtaining model data, use data and maintenance data of a target gas meter in a smart gas data center; determining a target time for replacing the target gas meter and uploading the target time to the smart gas data center based on the model data, use data and maintenance data of the target gas meter, wherein the smart gas data center is configured to send the target time to a smart gas service platform, and the smart gas service platform is configured to send the target time to a smart gas user platform.

One or more embodiments of the present disclosure provide a system for gas meter replacement prompt based on a smart gas Internet of Things, the system including a smart gas user platform, a smart gas service platform, a management platform of a smart gas device, a smart gas sensor network platform and a smart gas object platform, and the management platform of the smart gas device including a sub platform of the management platform of a smart gas indoor device and a smart gas data center, wherein the sub platform of the management platform of a smart gas indoor device is configured to perform the operations including: obtaining model data, use data and maintenance data of a target gas meter in a smart gas data center; determining a target time for replacing the target gas meter and uploading the target time to the smart gas data center based on the model data, use data and maintenance data of the target gas meter, wherein the smart gas data center is configured to send the target time to a smart gas service platform, and the smart gas service platform is configured to send the target time to a smart gas user platform.

One or more embodiments of the present disclosure provide a non-transitory computer-readable storage medium for storing computer instructions, wherein when the computer reads the computer instructions in the storage medium, the computer executes the method for gas meter replacement prompt based on a smart gas Internet of Things.

### BRIEF DESCRIPTION OF THE DRAWINGS

The present disclosure will be further described in the form of exemplary embodiments, which will be described in detail by the accompanying drawings. These embodiments are not restrictive. In these embodiments, the same number represents the same structure, wherein:

FIG. 1 is the platform structure diagram of system for gas meter replacement prompt based on a smart gas Internet of Things according to some embodiments of the present disclosure;

FIG. 2 is an exemplary flow chart of a process of the gas meter replacement prompt based on the smart gas Internet of Things according to some embodiments of the present disclosure;

FIG. 3 is an exemplary flow chart for determining a target time based on a target replacement prediction model according to some embodiments of the present disclosure;

FIG. 4 is a schematic diagram of the target replacement prediction model according to some embodiments of the present disclosure;

FIG. 5 is an exemplary flow chart for determining a target time based on a target algorithm according to some embodiments of the present disclosure;

FIG. 6 is an exemplary flow chart for determining a target time based on a first preset algorithm and a second preset algorithm according to some embodiments of the present disclosure;

FIG. 7 is an exemplary flowchart for determining a target time based on a second preset algorithm according to some embodiments of the present disclosure.

### DETAILED DESCRIPTION

In order to more clearly explain the technical scheme of the embodiments of the present disclosure, the following will briefly introduce the drawings that need to be used in the description of the embodiments. Obviously, the drawings in the following description are only some examples or embodiments of the present disclosure. For those skilled in the art, the present disclosure may also be applied to other similar scenarios according to these drawings without creative work. Unless it may be obvious from the language environment or otherwise stated, the same label in the figure represents the same structure or operation.

It should be understood that the “system”, “device”, “unit” and/or “module” used herein may be a method for distinguishing different components, elements, parts or assemblies at different levels. However, if other words may achieve the same purpose, they may be replaced by other expressions.

As shown in the description and the claims, unless the context expressly indicates exceptions, the words “a”, “an”, “the”, “one”, and/or “this” do not specifically refer to the singular form, but may also include the plural form; and the plural forms may be intended to include the singular forms as well, unless the context clearly indicates otherwise. Generally speaking, the terms “include” only indicate that the steps and elements that have been clearly identified are included, and these steps and elements do not constitute an exclusive list. Methods or device may also include other steps or elements.

A flowchart may be used in this disclosure to explain the operation performed by the system according to the embodiment of the present disclosure. It should be understood that the previous or subsequent operations are not necessarily performed accurately in order. Instead, the steps may be processed in reverse order or simultaneously. At the same time, other steps may be added to these processes, or one or more steps may be removed from these processes.

The Internet of Things system may be an information processing system that includes part or all of a user platform, a service platform, a management platform, a sensor network platform and an object platform. The user platform may be a functional platform to achieve user sensing information acquisition and control information generation. The service platform may realize a connection of the management platform and the user platform, and play a role of sensing information service communication and controlling information service communication. The management platform may realize the connection and collaboration between various functional platforms (such as the user platform and service platform). The management platform may gather information of an operation system of the Internet of Things, and may provide perception management and control management functions for the operation system of the Internet of Things. The service platform may realize the connection management platform and object platform, and play the role of sensing information service communication and controlling information service communication. The user platform may be a functional platform to achieve user sensing information acquisition and control information generation.

The information processing in the Internet of Things system may be divided into user sensing information processing flow and control information processing flow. The control information may be generated based on the user sensing information. In some embodiments, the control information may include user demand control information, and the user sensing information may include user query information. As used herein, the sensing information may be obtained by the object platform and transferred to the management platform through the sensor network platform. The user demand control information may be transmitted from the management platform to the user platform through the service platform, so as to control the sending of prompt information.

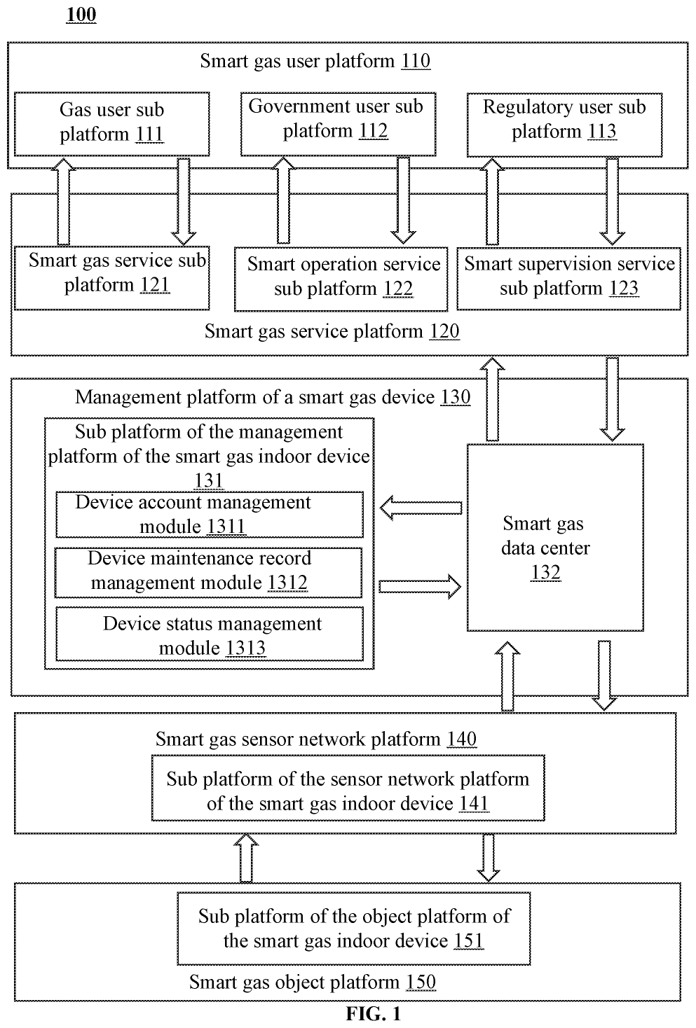

FIG. 1 is the platform structure diagram of system for gas meter replacement prompt based on a smart gas Internet of Things according to some embodiments of the present disclosure.

In some embodiments, the system for gas meter replacement prompt based on the smart gas Internet of Things 100 may include a smart gas user platform 110, a smart gas service platform 120, a management platform of a smart gas device 130, a smart gas sensor network platform 140, and a smart gas object platform 150.

In some embodiments, the system for gas meter replacement prompt based on the smart gas Internet of Things 100 may be configured to help users quickly and accurately judge a time for replacing a gas meter based on data information stored in the smart gas data center, such as model data, use data and maintenance data of the gas meter, when the user is not sure whether or when the gas meter should be replaced, it may provide guarantee for the user to use gas safely.

The smart gas user platform 110 may refer to a platform configured to obtain the model data, use data and maintenance data of gas meters and feed back a replacement time of gas meter to the user. In some embodiments, the smart gas user platform 110 may be configured as a terminal device, such as a mobile phone, tablet, computer, etc.

In some embodiments, the smart gas user platform 110 may include a gas user sub platform 111, a government user sub platform 112, and a regulatory user sub platform 113. In some embodiments of the present disclosure, the gas user sub platform 111 may play a major role. In some embodiments, the gas user sub platform 111 may feed back indoor gas meter replacement times to users for gas users (such as gas consumers). In some embodiments, the gas user sub platform 111 may interact with the smart gas service sub platform 121 to obtain a service of safe gas use. In some embodiments, the gas user sub platform 111 may issue a query instruction of the indoor gas meter replacement time to the smart gas service sub platform 121, and receive the indoor gas meter replacement time uploaded by the smart gas service sub platform 121.

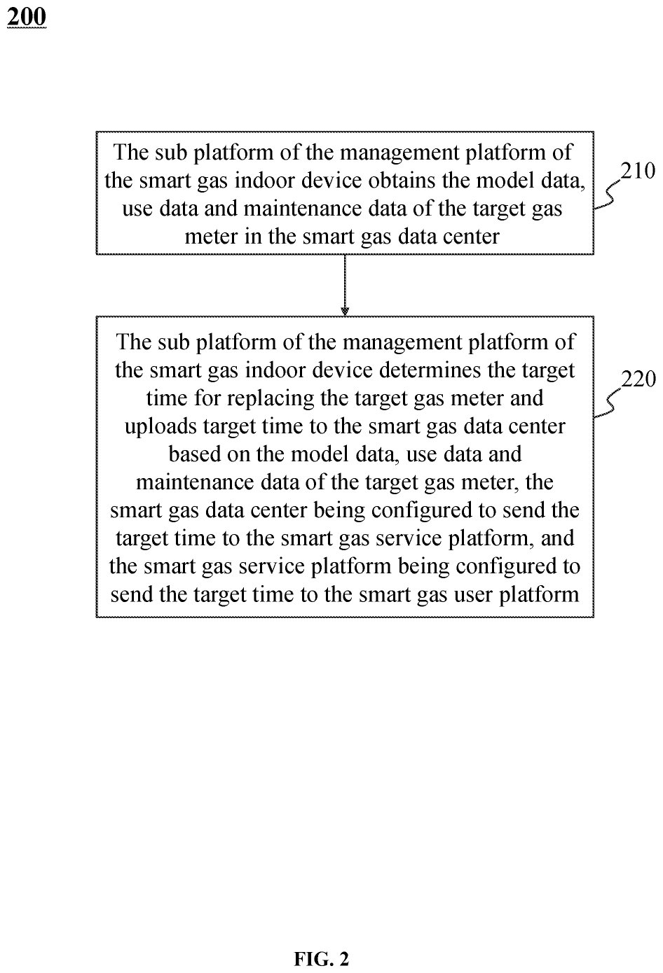

For more information about the model data, use data and maintenance data of the gas meter, see FIG. 2 and its related description.

The smart gas service platform 120 may refer to a platform for receiving and transmitting data and/or information.

In some embodiments, the smart gas service platform 120 may include the smart gas service sub platform 121, a smart operation service sub platform 122, and a smart supervision service sub platform 123. In some embodiments of the present disclosure, the smart gas service sub platform 121 may play a major role. In some embodiments, the smart gas service sub platform 121 may interact with the gas user sub platform 111 to provide gas users with information related to a gas device (such as gas meter replacement time). In some embodiments, the smart gas service sub platform 121 may interact with the management platform of the smart gas device 130, issue a query instruction of the indoor gas meter replacement time to a smart gas data center 132, and receive the indoor gas meter replacement time uploaded by the smart gas data center 132. In some embodiments, the smart gas service sub platform 121 may interact with the smart gas user platform 110, receive the query instruction of the indoor gas meter replacement time issued by the gas user sub platform 111, and upload the indoor gas meter replacement time to the gas user sub platform 111.

The management platform of the smart gas device 130 may refer to a platform that integrates and coordinates the connection and cooperation among various functional platforms, gathers all information of the Internet of Things, and provides perception management and control management functions for an Internet of Things operation system.

In some embodiments, the management platform of the smart gas device 130 may include a sub platform of the management platform of the smart gas indoor device 131 (also referred to as management sub-platform of the smart gas indoor device) and a smart gas data center 132. The sub platform of the management platform of the smart gas indoor device 131 may refer to a platform for obtaining and processing indoor device management data (such as the model data, use data, maintenance data, etc. of the gas meter). The smart gas data center 132 may refer to a platform configured to store relevant data of the indoor device (such as the indoor device management data, the processed indoor device management data, query instruction data, etc.) and coordinate the contact and cooperation between various platforms. In some embodiments, the indoor device management data of the smart gas data center 132 may be obtained through the smart gas sensor network platform 140 and the smart gas object platform 150; The processed indoor device management data may be obtained through the sub platform of the management platform of the smart gas indoor device 131; The query instruction data may be obtained through the smart gas service platform 120 and the smart gas user platform 110.

In some embodiments, the management platform of the smart gas device 130 may be configured to perform the acquisition of the model data, use data and maintenance data of the target gas meter in the smart gas data center 132; Based on the model data, use data and maintenance data of the target gas meter, determine the target time for replacing the target gas meter and upload the target time for replacing the target gas meter to the smart gas data center 132.

In some embodiments, the sub platform of the management platform of the smart gas indoor device 131 may interact bidirectional with the smart gas data center 132. The sub platform of the management platform of the smart gas indoor device 131 may obtain the indoor device management data from the smart gas data center 132 and feed it back, the smart gas data center 132 may collect and store all operating data of the system.

In some embodiments, the sub platform of the management platform of the smart gas indoor device 131 may include a device account management module 1311, a device maintenance record management module 1312, and a device status management module 1313. The device account management module 1311 may be configured to realize a diversified classification management of the gas devices by category and region. The device account management module 1311 may extract basic information such as the model, specification, quantity and location of the gas devices and information about an installation time and an operation time of the gas devices from the smart gas data center 132. The device maintenance record management module 1312 may be configured to extract maintenance records, repair records and patrol inspection record data of the gas devices from the smart gas data center 132, and may realize a firmware upgrade management of the gas devices. The device status management module 1313 may be configured to view a current operation status, an expected use age and other information of the gas devices. In some embodiments, the sub platform of the management platform of the smart gas indoor device 131 may also include other management modules, and different management modules may perform different functions, without limitation.

In some embodiments, the management platform of the smart gas device 130 may interact with the corresponding service sub platform and the corresponding sensor network sub platform through the smart gas data center 132. In some embodiments, the smart gas data center 132 may receive the query instruction of the gas device replacement time issued by the smart gas service platform 120. The smart gas data center 132 may send relevant data of the gas device (such as the model data, use data, maintenance data, etc. of the gas meter) to the sub platform of the management platform of the smart gas indoor device 131 for analysis and processing. As used herein, different types of information may be analyzed and processed through the above different management modules. The sub platform of the management platform of the smart gas indoor device 131 may send the analyzed and processed data to the smart gas data center 132, and the smart gas data center 132 may send summarized and processed data (such as the replacement time of the gas meter) to the smart gas service platform 120. In some embodiments, the smart gas data center 132 may send an instruction to obtain the relevant data of the gas device to the smart gas sensor network platform 140, and receive the relevant data of gas device uploaded by the smart gas sensor network platform 140.

The smart gas sensor network platform 140 may refer to a platform for unified management of sensor communication. In some embodiments, the smart gas sensor network platform 140 may be configured as a communication network and gateway. The smart gas sensor network platform 140 may adopt a plurality of groups of gateway servers or a plurality of groups of intelligent routers, and there are no too many restrictions here.

In some embodiments, the smart gas sensor network platform 140 may include a sub platform of the sensor network platform of the smart gas indoor device 141. In some embodiments, the sub platform of the sensor network platform of the smart gas indoor device 141 may interact with a sub platform of the object platform of the smart gas indoor device 151, issue a command to obtain the gas device-related data to the sub platform of the object platform of the smart gas indoor device 151, and receive the gas device-related data uploaded by the sub platform of the object platform of the smart gas indoor device 151. In some embodiments, the sub platform of the sensor network platform of the smart gas indoor device 141 may interact with the smart gas data center 132, receive an instruction of obtaining the gas device-related data issued by the smart gas data center 132, and upload the gas device-related data to the smart gas data center 132.

The smart gas object platform 150 may refer to a platform for obtaining the gas device-related data. In some embodiments, the smart gas object platform 150 may be configured as various gas devices, such as gas meters.

In some embodiments, the smart gas object platform 150 may include the sub platform of the object platform of the smart gas indoor device 151. In some embodiments, the sub platform of the object platform of the smart gas indoor device 151 may interact with the sub platform of the sensor network platform of the smart gas indoor device 141, receive the instruction of obtaining the gas device related data issued by the sub platform of the sensor network platform of the smart gas indoor device 141, and upload the gas device related data to the smart gas data center 132 through the sub platform of the sensor network platform of the smart gas indoor device 141.

FIG. 2 is an exemplary flow chart of a process of the gas meter replacement prompt based on the smart gas Internet of Things according to some embodiments of the present disclosure. In some embodiments, the process 200 may be executed by the sub platform of the management platform of the smart gas indoor device 131. As shown in FIG. 2, the process 200 may include following steps.

In step 210, the sub platform of the management platform of the smart gas indoor device obtains the model data, use data and maintenance data of the target gas meter in the smart gas data center.

The target gas meter may refer to a gas meter whose replacement time is needed to be determined.

The model data may refer to fixed self-data of the gas meter. For example, the model data may include but not limited to a brand and a model (also referred to as type) of the target gas meter, a gas type (such as natural gas, liquefied petroleum gas, etc.), etc. The model data may be text data information of the target gas meter. The aforementioned text data information may include the brand and model of the target gas meter, and the corresponding gas type (such as natural gas, liquefied petroleum gas, etc.). In some embodiments, the model data may also be other data. For example, the model data may also be picture data information of the target gas meter. The aforementioned picture data information may include the brand and model of the target gas meter, and the corresponding gas type (such as natural gas, liquefied petroleum gas, etc.).

The use data may refer to data related to a use of the gas meter. For example, a cumulative service time (calculated from an installation time), a service intensity (such as a service frequency, a gas consumption amount per unit time, etc.) of the gas meter.

The maintenance data may refer to data related to the maintenance information of the gas meter. For example, a count of maintenances, a maintenance degree (such as major repair and minor repair), a maintenance time, etc., of the gas meter.

In some embodiments, the sub platform of the management platform of the smart gas indoor device may obtain the model data, use data and maintenance data of the target gas meter based on historical data of the smart gas data center. In some embodiments, the sub platform of the management platform of the smart gas indoor device may exclude the gas meter in houses where no one lives according to a use intensity of the gas meter. The sub platform of the management platform of the smart gas indoor device may also obtain the model data, use data and maintenance data of the target gas meter in other ways, which may be not limited here.

In step 220, the sub platform of the management platform of the smart gas indoor device determines the target time for replacing the target gas meter and uploads target time to the smart gas data center based on the model data, use data and maintenance data of the target gas meter, the smart gas data center being configured to send the target time to the smart gas service platform, and the smart gas service platform being configured to send the target time to the smart gas user platform.

The target time may refer to a replacement time of the target gas meter. For example, if the target time is 0, which may mean that the target gas meter should be replaced immediately. For another example, the target time is 2.4 years, which may mean that the target gas meter should be replaced after 2.4 years at the latest.

For more information about the smart gas user platform, smart gas service platform, sub platform of the management platform of the smart gas indoor device and smart gas data center, see FIG. 1 and its related descriptions.

In some embodiments, the sub platform of the management platform of the smart gas indoor device may conduct modeling or adopt various data analysis algorithms, such as regression analysis, discriminant analysis, etc., to process the model data, use data and maintenance data of the target gas meter, and determine the target time for replacing the target gas meter.

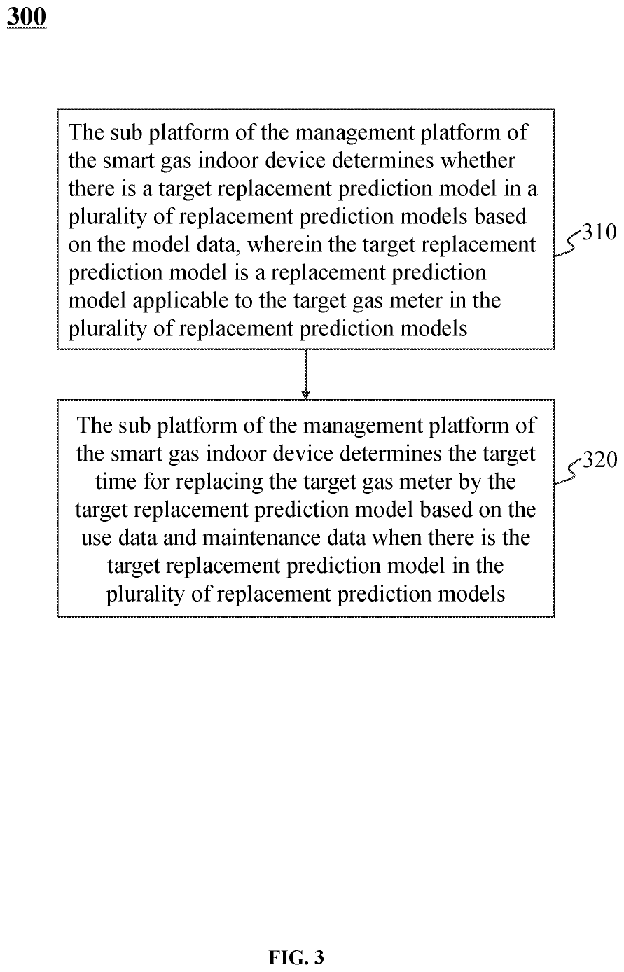

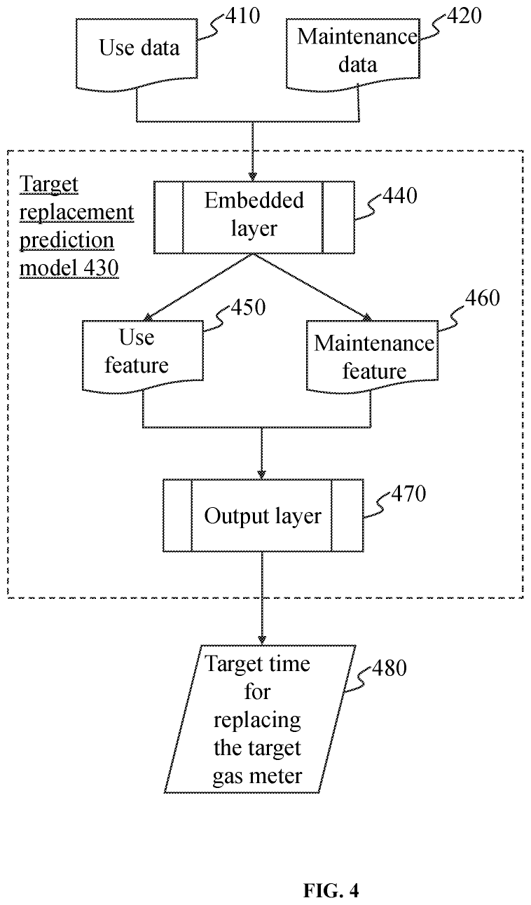

In some embodiments, the sub platform of the management platform of the smart gas indoor device may use the target replacement prediction model to determine the target time for replacing the target gas meter based on the model data of the target gas meter. For more information about the target replacement prediction model, see FIGS. 3 and 4 and their related descriptions.

In some embodiments of the present disclosure, determining the target time for replacing the target gas meter based on the model data, use data and maintenance data of the target gas meter may help users quickly and accurately determine the necessity and time for replacing the gas meter, and strengthen the guarantee for users to use gas safely. In addition, the management platform of the smart gas device may directly obtain the model data, use data and maintenance data of the target gas meter from the smart gas data center, and gas-related work staff may not have to go door to door to check, which not only reduces the workload of work staff, but also improves the work efficiency.

It should be noted that the above description of process 200 may be only for example and description, and does not limit the scope of application of the present disclosure. For those skilled in the art, various modifications and changes may be made to process 200 under the guidance of the present disclosure. However, these amendments and changes are still within the scope of the present disclosure.

FIG. 3 is an exemplary flow chart for determining a target time based on a target replacement prediction model according to some embodiments of the present disclosure. In some embodiments, the process 300 may be executed by the sub platform of the management platform of the smart gas indoor device 131. As shown in FIG. 3, the process 300 may include following steps.

In step 310, the sub platform of the management platform of the smart gas indoor device determines whether there is a target replacement prediction model in a plurality of replacement prediction models based on the model data, wherein the target replacement prediction model is a replacement prediction model applicable to the target gas meter in the plurality of replacement prediction models.

A replacement prediction model may refer to a model configured to predict the replacement time of a gas meter. In some embodiments, a plurality of replacement prediction models may be machine learning models for predicting the replacement time of gas meters, and each of the plurality of replacement prediction models may be applicable to a model of the gas meter. For example, a gas meter in a certain type (gas meter model) may use the corresponding replacement prediction model to predict the replacement time.

In some embodiments, the sub platform of the management platform of the smart gas indoor device may train different replacement prediction models according to the model data of different gas meters, and the model data may include the gas meter model. For more information on the model data, see FIG. 2 and its related description.

In some embodiments, a replacement prediction model may include an embedded layer and an output layer. The output of the embedded layer may be used as the input of the output layer.

For each of the plurality of replacement prediction models, the sub platform of the management platform of the smart gas indoor device may perform joint training on each layer of the replacement prediction model. A training sample may include the maintenance data and use data of a certain model of historical gas meter. A label of the training sample may include a target time for replacement of the historical gas meter in the same model as the target gas meter. The above training samples may be determined through historical user data of the smart gas data center, and the training labels may be determined based on data of a meter change record of the smart gas data center. The maintenance data and use data of historical gas meters in the plurality of training samples may be input into an initial embedded layer. The output of the initial embedded layer may be input into an initial output layer, and a loss function may be constructed based on an output of the initial output layer and the corresponding labels of the training samples. The parameters of the initial embedded layer and the initial output layer may be updated iteratively based on the loss function until the preset conditions are met. The parameters in the embedded layer and the output layer may be determined, and the trained replacement prediction model may be obtained. The preset conditions may include, but be not limited to, a loss function convergence, a training period reaching a threshold, etc.

The sub platform of the management platform of the smart gas indoor device may determine the model of each applicable gas meter used in the plurality of replacement prediction models. The sub platform of the management platform of the smart gas indoor device may determine the model of the target gas meter based on the model data of the target gas meter. The sub platform of the management platform of the smart gas indoor device may determine whether there is the target replacement prediction model by judging whether there is a target gas meter model among the gas meter models applicable to each replacement prediction model. As used herein, the target replacement prediction model may refer to the model configured to predict the replacement time of a gas meter in the corresponding model (type). For example, a model of a gas meter is G2.5, and a model configured to predict the replacement time of G2.5 in the replacement prediction model may be the target replacement prediction model of the gas meter. The target replacement prediction model may include an embedded layer and a target output layer. For more information about the target replacement prediction model, see FIG. 4 and its related description.

In step 320, the sub platform of the management platform of the smart gas indoor device determines the target time for replacing the target gas meter by the target replacement prediction model based on the use data and maintenance data when there is the target replacement prediction model in the plurality of replacement prediction models.

When there is the target replacement prediction model in the plurality of replacement prediction models, the target replacement prediction model may process the use data and maintenance data of the target gas meter to determine the target time. For more details on determining the target time through the target replacement prediction model, see FIG. 4 and its related description.

In some embodiments of the present disclosure, the target time may be determined by analyzing the model data, use data and maintenance data with the target replacement prediction model, which improves the accuracy of the target time and makes the conclusion more consistent with the actual situation.

FIG. 4 is a schematic diagram of the target replacement prediction model according to some embodiments of the present disclosure.

In some embodiments, the target replacement prediction model may process the use data and maintenance data of the target gas meter to determine the target time. As shown in FIG. 4, the target replacement prediction model 430 may include an embedded layer 440 and a target output layer 470. As used herein, the output of the embedded layer 440 may be used as the input of the target output layer 470.

In some embodiments, the embedded layer may process the maintenance data and use data to determine a maintenance feature 460 and a use feature 450 of the target gas meter. As shown in FIG. 4, the input of the embedded layer 440 may include the maintenance data 420 and the use data 410 of the target gas meter, and the output may include the maintenance feature 460 and the use feature 450 of the target gas meter. The embedded layer 440 may be a variety of possible machine learning models. For example, the embedded layer 440 may be a BERT model. In some embodiments, the embedded layer may be shared by multiple different replacement prediction models.

A use feature may be a feature vector representing the use data of the target gas meter. Locations of the elements in use features may represent cumulative service times and service intensities, etc., of different target gas meters. Values of the elements in the use feature 450 may be configured to represent a specific cumulative service time and an intensity, etc. of the target gas meter. For example, the use feature may be (3.1, 7, 1.5, 30, 1.2), which means that the cumulative service time of the target gas meter is 3.1 years, an average daily consumption in last 7 days is 1.5 cubic meters, and an average daily consumption in the 30 days is 1.2 cubic meters.

A maintenance feature may be a maintenance data feature vector representing the target gas meter. Locations of elements in maintenance features may indicate a count of maintenances, major/minor repair, and maintenance times of different target gas meters. Values of the elements in the maintenance data feature vector may represent a specific count of maintenances, major/minor repair, and maintenance time of the target gas meter. For example, the maintenance feature may be (3, 1, 2, 1, 0.8, 1.5, 2.5), which means that the target gas meter has been repaired three times, first and third maintenance results are 1, a second maintenance result is 2, and three maintenance times are 0.8, 1.5, and 2.5 years ago respectively. According to a preset correspondence table, the maintenance result of 1 may indicate the minor repair, and the maintenance result of 2 may indicate the major repair.

In some embodiments, the target output layer may process the maintenance feature and use feature corresponding to the target gas meter, and determine a target time for replacing the target gas meter. As shown in FIG. 4, input of the target output layer 470 may include the maintenance feature 460 and the use feature 450, and output of the target output layer 470 may include the target time 480 for replacing the target gas meter. The target output layer 470 may be a deep learning model.

See FIG. 3 and its related description for more information about training the target replacement prediction model 430. It should be understood that when the target replacement prediction model 430 is trained, the training samples and labels may be related data to a gas meter with a same model as the target gas meter.

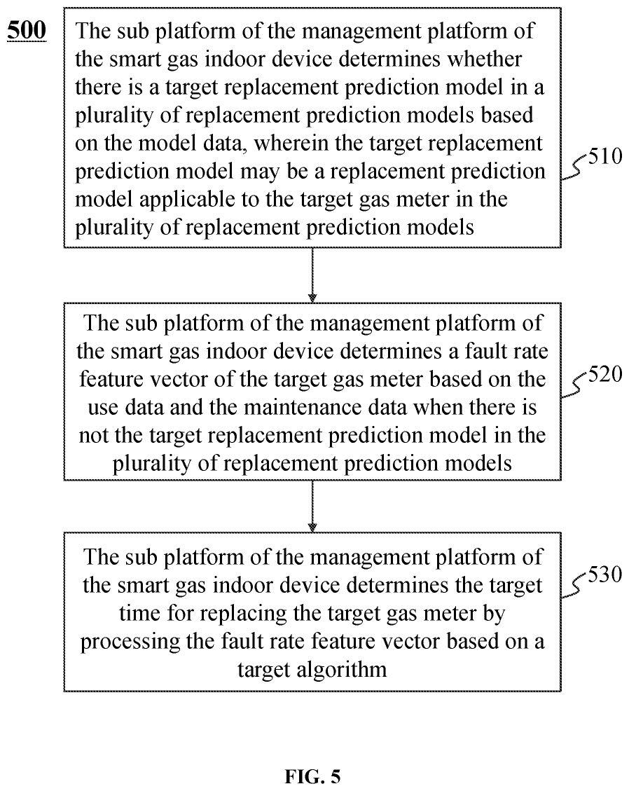

FIG. 5 is an exemplary flow chart for determining a target time based on a target algorithm according to some embodiments of the present disclosure. In some embodiments, the process 500 may be executed by the sub platform of the management platform of the smart gas indoor device 131. As shown in FIG. 5, the process 500 may include following operations.

In step 510, the sub platform of the management platform of the smart gas indoor device determines whether there is a target replacement prediction model in a plurality of replacement prediction models based on the model data, wherein the target replacement prediction model may be a replacement prediction model applicable to the target gas meter in the plurality of replacement prediction models.

For more information on the model data and the target gas meter, see FIG. 2 and its related description. For more information about the replacement prediction models, target replacement prediction model and determination method thereof, see FIG. 3 and its related description.

In step 520, the sub platform of the management platform of the smart gas indoor device determines a fault rate feature vector of the target gas meter based on the use data and the maintenance data when there is not the target replacement prediction model in the plurality of replacement prediction models.

Refer to FIG. 2 and its related description for more information about the use data and maintenance data.

The fault rate feature vector may be configured to represent a probability of failure of the target gas meter in different use cycles since an installation of the target gas meter. For example, the fault rate feature vector (0, 10, 15) may indicate that the target gas meter has been used for three years since its installation. The failure rate may be 0 in a first year, 10% in a second year, and 15% in a third year. As another example, the fault rate feature vector (10, 14, 20) may indicate that the target gas meter has been used for six years since its installation, with a failure rate of 10% in first and second years, 14% in third and fourth years, and 20% in fifth and sixth years.

In some embodiments, the sub platform of the management platform of the smart gas indoor device may obtain a fault rate feature vector based on the embedded layer of the target replacement prediction model. The embedded layer of the target replacement prediction model may output the use feature and maintenance feature of the target gas meter by processing the use data and maintenance data of the target gas meter. Then the fault rate feature vector of the target gas meter may be determined based on the use feature and maintenance feature of the target gas meter. For more information about the embedded layer, see FIG. 4 and its related description.

In step 530, the sub platform of the management platform of the smart gas indoor device determines the target time for replacing the target gas meter by processing the fault rate feature vector based on a target algorithm.

The target algorithm may refer to an algorithm configured to determine the target time for replacing the target gas meter, for example, clustering algorithms.

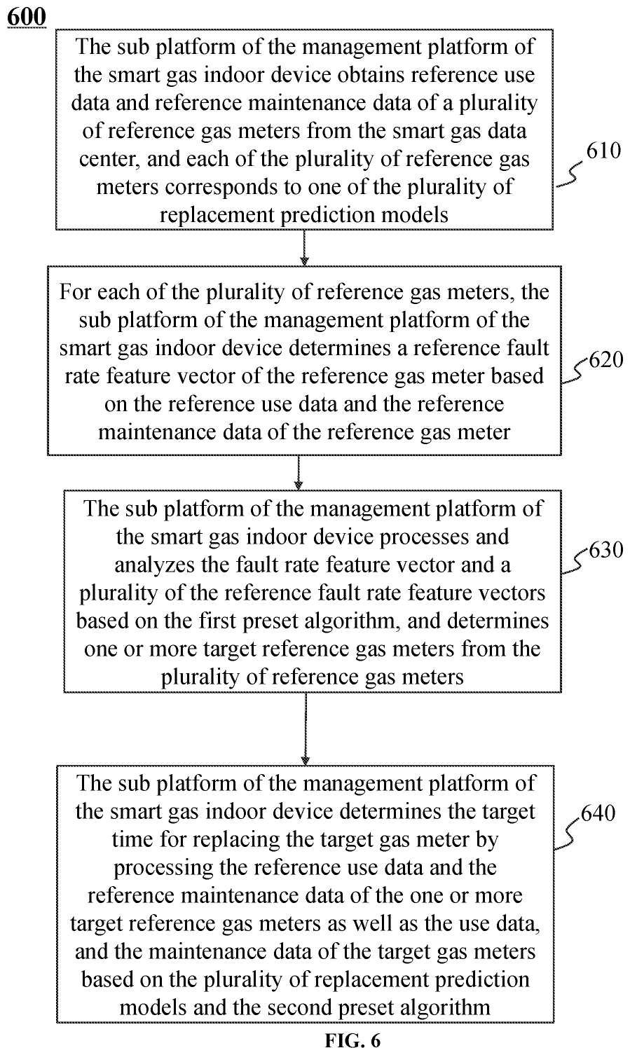

In some embodiments, the target algorithm may include a first preset algorithm and a second preset algorithm. For more information about the first preset algorithm and the second preset algorithm, see FIG. 6 and its related description.

In some embodiments, the sub platform of the management platform of the smart gas indoor device may process the fault rate feature vector based on various target algorithms for data analysis (such as regression analysis, discriminant analysis, clustering analysis, etc.) to determine the target time for replacing the target gas meter.

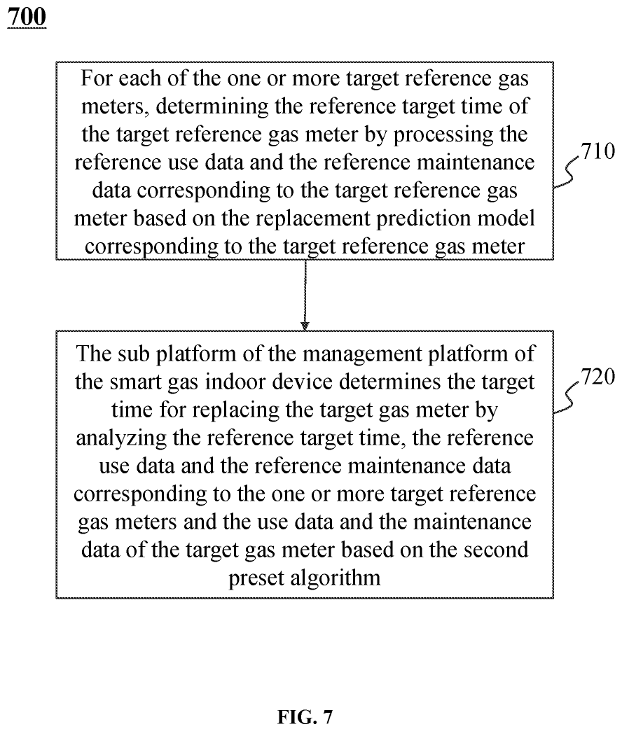

In some embodiments, the sub platform of the management platform of the smart gas indoor device may use the first preset algorithm and the second preset algorithm to process the fault rate feature vector and determine the target time for replacing the target gas meter. For more information about using the first preset algorithm and the second preset algorithm to determine the target time, see FIGS. 6 and 7 and their related descriptions.

Some embodiments of the present disclosure process the fault rate feature vector of the target gas meter through the preset algorithm to determine the target time for replacement of the target gas meter, which can solve a problem of how to determine the target time when there is no target replacement prediction model. In addition, combining the target replacement prediction model and target algorithm to determine the target time may fully cover all possible situations of the target gas meter, with stronger applicability.

FIG. 6 is an exemplary flow chart for determining a target time based on the first preset algorithm and the second preset algorithm according to some embodiments of the specification. In some embodiments, the process 600 may be executed by the sub platform of the management platform of the smart gas indoor device 131. As shown in FIG. 6, the process 600 may include following operations.

In step 610, the sub platform of the management platform of the smart gas indoor device obtains reference use data and reference maintenance data of a plurality of reference gas meters from the smart gas data center, and each of the plurality of reference gas meters corresponds to one of the plurality of replacement prediction models.

A reference gas meter may refer to a gas meter suitable for a replacement prediction model. For more information on the replacement prediction model, see FIGS. 3 and 4 and their related descriptions. The reference use data may refer to use data of the reference gas meter. For more information about the use data, see FIG. 2 and its related description. The reference maintenance data may refer to the maintenance data of the reference gas meter. For more information on the maintenance data, see FIG. 2 and its related description.

In some embodiments, the sub platform of the management platform of the smart gas indoor device may obtain the reference use data and reference maintenance data of the reference gas meter based on historical data of the smart gas data center. The sub platform of the management platform of the smart gas indoor device may also obtain the reference use data and reference maintenance data of the reference gas meter through other methods.

In step 620, for each of the plurality of reference gas meters, the sub platform of the management platform of the smart gas indoor device determines a reference fault rate feature vector of the reference gas meter based on the reference use data and the reference maintenance data of the reference gas meter.

The reference fault rate feature vector may refer to the fault rate feature vector of the reference gas meter. For more information about the fault rate feature vector, see FIG. 5 and its related description.

In some embodiments, the management platform of the smart gas device may obtain the reference fault rate feature vector based on the embedded layer of the replacement prediction model. The embedded layer of the replacement prediction model may determine the reference fault rate feature vector of the reference gas meter by processing the reference use data and the reference maintenance data of the reference gas meter. For more information about the embedded layer, see FIG. 4 and its related description.

In step 630, the sub platform of the management platform of the smart gas indoor device processes and analyzes the fault rate feature vector and a plurality of the reference fault rate feature vectors based on the first preset algorithm, and determines one or more target reference gas meters from the plurality of reference gas meters.

The first preset algorithm may refer to an algorithm for determining one or more target reference gas meters. In some embodiments, the first preset algorithm may be a clustering algorithm.

The target reference gas meter may refer to a reference gas meter whose reference use data, reference maintenance data and reference fault rate feature vector is similar to those of the target gas meter.

In some embodiments, the management platform of the smart gas device may use the clustering algorithm to process the fault rate feature vector and each reference fault rate feature vector to determine the target reference gas meter(s). In some embodiments, the management platform of the smart gas device may determine the target reference gas meter(s) by vector matching method. For example, vector distance calculation methods (such as Euclidean distance, Manhattan distance, Chebyshev distance, included angle cosine distance, etc.) may be used to calculate a distance between the fault rate feature vector and each reference fault rate feature vector, and determine one or more reference gas meters whose distance(s) is less than a preset distance threshold as the target reference gas meter(s).

In step 640, the sub platform of the management platform of the smart gas indoor device determines the target time for replacing the target gas meter by processing the reference use data and the reference maintenance data of the one or more target reference gas meters as well as the use data and the maintenance data of the target gas meters based on the plurality of replacement prediction models and the second preset algorithm.

For more information about the use data and maintenance data of the target gas meter, see FIG. 2 and its related descriptions, and for more information about the replacement prediction model, see FIGS. 3 and 4 and their related descriptions.

In some embodiments, the sub platform of the management platform of the smart gas indoor device may process the reference use data and the reference maintenance data of the one or more target reference gas meters as well as the use data and the maintenance data of the target gas meter based on the plurality of replacement prediction models and the second preset algorithm, and determine the target time for replacing the target gas meter. As used herein, the second preset algorithm may be various feasible algorithms, such as a machine learning algorithm.

In some embodiments, the sub platform of the management platform of the smart gas indoor device may process the reference use data and reference maintenance data corresponding to the target reference gas meter(s) based on the replacement prediction model(s) corresponding to the target reference gas meter(s), and determine the reference target time(s) of the target reference gas meter(s). Further, the second preset algorithm may be configured to analyze the reference target time(s), reference use data, reference maintenance data of the target reference gas meter(s) as well as the use data and maintenance data of the target gas meter, and determine the target time for replacing the target gas meter.

For more information about the reference target time and the second preset algorithm, see FIG. 7 and its related description.

FIG. 7 is an exemplary flowchart for determining a target time based on a second preset algorithm according to some embodiments of the present disclosure. In some embodiments, the process 700 may be executed by the sub platform of the management platform of the smart gas indoor device 131. As shown in FIG. 7, the process 700 may include following operations.

In step 710, for each of the one or more target reference gas meters, determining the reference target time of the target reference gas meter by processing the reference use data and the reference maintenance data corresponding to the target reference gas meter based on the replacement prediction model corresponding to the target reference gas meter.

The reference target time may refer to a time for replacement of the target reference gas meter. For more information on target time, see FIG. 2 and its related description.

In some embodiments, the sub platform of the management platform of the smart gas indoor device may process the reference use data and reference maintenance time corresponding to the target reference gas meter based on the replacement prediction model corresponding to the target reference gas meter, and determine the reference target time of the target reference gas meter. See FIG. 4 and its related description for more information about using the replacement prediction model to determine the target time.

In step 650, determining the target time for replacing the target gas meter by analyzing the reference target time(s), the reference use data and the reference maintenance data of the one or more target reference gas meters as well as the use data and the maintenance data of the target gas meter based on the second preset algorithm.

The second preset algorithm may refer to an algorithm for determining the target time for replacing the target gas meter. For example, the second preset algorithm may include, but may be not limited to, a sum algorithm, an average algorithm, and the like.

In some embodiments, the second preset algorithm may include following operations.

The sub platform of the management platform of the smart gas indoor device may use following formulas (1) and (2) to calculate the target time for replacing the target gas meter.

P_{i(i=1,2 . . . k)}=Σ(Aⱼ*Lⱼ*e^{(r}^{ⱼᵢ}^{-R}^{ᵢ}⁾_{(j=1,2 . . . n)} (1)

P=average(Pᵢ) (2)

For formula (1), where Lⱼ represents the reference target times of target reference gas meters in different models. j represents the models of the target reference gas meters. For example, the target reference gas meters that use the same replacement prediction model according to the model data may be classified into one category. When j=1, it may represent model one of the target reference gas meters; When j=2, it may represent model two of the target reference gas meters. As another example, supposing there are three different types of target reference gas meters, j=1, 2, 3, L₁=1.01 year, L₂=1.03 years, L₃=1.06 years, which means that the reference target time of target reference gas meter in model one may be 1.01 years, the reference target time of target reference gas meter in model two may be 1.03 years, and the reference target time of target reference gas meter in model three may be 1.06 years.

Aⱼ may be a weight coefficient. In some embodiments, Aⱼ may change according to Lⱼ, the larger Lⱼ, the smaller Aⱼ; conversely, the smaller Lⱼ, the larger Aⱼ. For example, there may be target reference gas meters in three different models, if L₁>L₂>L₃, then A₁<A₂<A₃.

e represents irrational number.

rⱼᵢ represents a reference vector of the target reference gas meter. The reference vector may refer to a mean value of a vector corresponding to the reference use data and reference maintenance data of the target reference gas meter. i represents a count of elements in the reference vector. For example, when j=1, r=2, r₁₂ represents two elements contained in the reference vector of the target reference gas meter of model one, the two elements may respectively represent a use age in the reference use data and a count of maintenances in the reference maintenance data of the target reference gas meter, and may also represent the reference use data and other data contained in the reference maintenance data of the target reference gas meter. For example, when j=2, r=1, r₂₁ means that the reference vector of the target reference gas meter of model two only contains one element, the one element may represent the use age in the reference use data of the target reference gas meter, the count of maintenances in the reference maintenance data of the target reference gas meter, and other data contained in the reference use data and reference maintenance data of the target reference gas meter. In some embodiments, target reference gas meter in the same model may include at least one target reference gas meter. The target reference gas meter in the same model may be represented by a reference vector. In some embodiments, when the target reference gas meter in the same model includes a plurality of target reference gas meters, the reference use data and reference maintenance data of the plurality of target reference gas meters may be averaged to obtain the reference vector of the target reference gas meter in the model. For example, when there are target reference gas meters in three models, and the reference vector may contain two elements, as shown in Table 1:

TABLE 1

| | | | A count of |
|---|---|---|---|
| | | | maintenances |
| Models of the gas | Serial number of | Use ages | (number of |
| meters | the gas meters | (year) | times) |
| Model one | 1 | 3 | 2 |
| | 2 | 3.3 | 3 |
| | 3 | 3.6 | 4 |

Average use age of the gas meters in model one r₁₁ is 3.3, an average
value of a count of maintenances of the gas meters in model one r₁₂
is 3, the reference vector is (3.3, 3)

| | | | |
|---|---|---|---|
| Model two | 4 | 3.1 | 4 |
| | 5 | 3.2 | 2 |
| | 6 | 3.3 | 3 |

Average use age of the gas meters in model two r₂₁ is 3.2, an average
value of a count of maintenances of the gas meters in model two r₂₂
is 3, the reference vector is (3.2, 3)

| | | | |
|---|---|---|---|
| Model three | 7 | 3.4 | 3 |
| | 8 | 3.6 | 2 |
| | 9 | 3.2 | 4 |

Average use age of the gas meters in model three r₃₁ is 3.4, an average
value of a count of maintenances of the gas meters in model three r₃₂
is 3, the reference vector is (3.4, 3)

Rᵢ represents a representative vector of the target gas meter. The representative vector may refer to an average value of the vector corresponding to the use data and maintenance data of the target gas meter, and the elements of the representative vector may correspond to the elements of the reference vector. For example, if the reference vector contains the use age and the count of maintenances of the target reference gas meter, the representative vector may also contain the use age and the count of maintenances of the target gas meter. As another example, the representative vector may be (3.1, 3), which means that the use age of the target gas meter is 3.1 years and the count of the maintenances is 3.

Pᵢ in formula (1) represents a target time component calculated by processing the reference target time, reference use data, reference maintenance data of target reference gas meters of different models and the use data and maintenance data of target gas meters of different models. P in formula (2) represents a target time for replacement of target gas meter which is finally determined by weighted summation of the target time component Pᵢ. In some embodiments, the sub platform of the management platform of the smart gas indoor device may use formula (1) to calculate the target time component, and then bring the target time component into formula (2) to calculate the target time for replacing the target gas meter.

In some embodiments, when Rᵢ=0 (i.e., the target gas meter is a brand-new gas meter), giving Pᵢ a larger value (for example, the reasonable maximum use age M of the gas meter of the model). During the calculation using formula (1), a maximum value of Pᵢ may not exceed the reasonable maximum use age M of the gas meter of the model. If the calculation result exceeds M, Pᵢ=M.

In some embodiments of the present disclosure, for target gas meters that cannot use the target replacement prediction model to determine the target replacement time, the target replacement time of the target gas meter may be determined, based on the predicted replacement reference target time of the target reference gas meter similar to the target gas meter, by using the first preset algorithm and the second preset algorithm. Thus, the basis for predicting the target time may be more reasonable, the accuracy of the calculated target time may be guaranteed, and the demand of the user for quickly and accurately obtaining the replacement time of the gas meter may be met.

The present disclosure also provides a non-transitory computer-readable storage medium, which stores computer instructions. When the computer reads the computer instructions in the storage medium, the computer may execute the method for gas meter replacement prompt based on a smart gas Internet of Things as described in any of the embodiments of the present disclosure.

The basic concepts have been described above. Obviously, for those skilled in the art, the above detailed disclosure may be only an example and does not constitute a limitation of the present disclosure. Although it may be not explicitly stated here, those skilled in the art may make various modifications, improvements, and amendments to the present disclosure. Such modifications, improvements and amendments are suggested in the present disclosure, so such modifications, improvements and amendments still belong to the spirit and scope of the exemplary embodiments of the present disclosure.

Meanwhile, the present disclosure uses specific words to describe the embodiments of the present disclosure. For example, “one embodiment”, and/or “some embodiments” mean a certain feature or structure related to at least one embodiment of the present disclosure. Therefore, it should be emphasized and noted that “one embodiment” or “an alternative embodiment” mentioned twice or more in different positions in the present disclosure does not necessarily refer to the same embodiment. In addition, certain features or structures in one or more embodiments of the present disclosure may be appropriately combined.

In addition, unless explicitly stated in the claims, the sequence of processing elements and sequences, the use of numbers and letters, or the use of other names described in the present disclosure are not configured to define the sequence of processes and methods in the present disclosure. Although the above disclosure has discussed some currently considered useful embodiments of the invention through various examples, it should be understood that such details are only for the purpose of explanation, and the additional claims are not limited to the disclosed embodiments. On the contrary, the claims are intended to cover all amendments and equivalent combinations that conform to the essence and scope of the embodiments of the present disclosure. For example, although the system components described above may be implemented by hardware devices, they may also be implemented only by software solutions, such as installing the described system on an existing server or mobile device.

Similarly, it should be noted that, in order to simplify the description disclosed in the present disclosure and thus help the understanding of one or more embodiments of the invention, the foregoing description of the embodiments of the present disclosure sometimes incorporates a variety of features into one embodiment, the drawings or the description thereof. However, this disclosure method does not mean that the object of the present disclosure requires more features than those mentioned in the claims. In fact, the features of the embodiments are less than all the features of the single embodiments disclosed above.

In some embodiments, numbers describing the number of components and attributes are used. It should be understood that such numbers used in the description of embodiments are modified by the modifier “about”, “approximate” or “generally” in some examples. Unless otherwise stated, “approximately” or “generally” indicate that a ±20% change in the figure may be allowed. Accordingly, in some embodiments, the numerical parameters used in the description and claims are approximate values, and the approximate values may be changed according to the characteristics required by individual embodiments. In some embodiments, the numerical parameter should consider the specified significant digits and adopt the method of general digit reservation. Although the numerical fields and parameters configured to confirm the range breadth in some embodiments of the present disclosure are approximate values, in specific embodiments, the setting of such values may be as accurate as possible within the feasible range.

For each patent, patent application, patent application disclosure and other materials cited in the present disclosure, such as articles, books, specifications, publications, documents, etc., the entire contents are hereby incorporated into the present disclosure for reference. Except for the application history documents that are inconsistent with or conflict with the contents of the present disclosure, and the documents that limit the widest range of claims in the present disclosure (currently or later appended to the present disclosure). It should be noted that in case of any inconsistency or conflict between the description, definitions, and/or use of terms in the supplementary materials of the present disclosure and the contents described in the present disclosure, the description, definitions, and/or use of terms in the present disclosure shall prevail.

Finally, it should be understood that the embodiments described in the present disclosure are only configured to illustrate the principles of the embodiments of the present disclosure. Other deformations may also fall within the scope of the present disclosure. Therefore, as an example rather than a limitation, the alternative configuration of the embodiments of the present disclosure may be regarded as being consistent with the teachings of the present disclosure. Accordingly, the embodiments of the present disclosure are not limited to those explicitly introduced and described in the present disclosure.

What is claimed is:

1. A method for gas meter replacement prompt based on a smart gas Internet of Things, the method being applied to a sub platform of a management platform of a smart gas indoor device, wherein the method comprises:
obtaining model data, use data, and maintenance data of a target gas meter in a smart gas data center;
determining a target time for replacing the target gas meter and uploading the target time to the smart gas data center based on the model data, use data and maintenance data of the target gas meter, wherein the smart gas data center is configured to send the target time to a smart gas service platform, and the smart gas service platform is configured to send the target time to a smart gas user platform.

2. The method for gas meter replacement prompt based on a smart gas Internet of Things of claim 1, wherein determining a target time for replacing the target gas meter based on the model data, use data and maintenance data of the target gas meter includes:
determining whether there is a target replacement prediction model in a plurality of replacement prediction models based on the model data, wherein the target replacement prediction model is a replacement prediction model applicable to the target gas meter in the plurality of replacement prediction models; and
determining the target time for replacing the target gas meter by the target replacement prediction model based on the use data and the maintenance data when there is the target replacement prediction model in the plurality of replacement prediction models.

3. The method for gas meter replacement prompt based on a smart gas Internet of Things of claim 2, wherein the plurality of replacement prediction models are machine learning models for predicting replacement times of gas meters, and each of the plurality of replacement prediction models is applicable to the gas meters of one model.

4. The method for gas meter replacement prompt based on a smart gas Internet of Things of claim 3, wherein the target replacement prediction model comprises an embedded layer and a target output layer, wherein
the embedded layer is configured to process the use data and the maintenance data of the target gas meter to obtain a use feature and a maintenance feature;
the target output layer is configured to process a model feature, the use feature, and the maintenance feature to obtain the target time for replacing the target gas meter.

5. The method for gas meter replacement prompt based on a smart gas Internet of Things of claim 4, wherein the embedded layer is shared by the plurality of replacement prediction models.

6. The method for gas meter replacement prompt based on a smart gas Internet of Things of claim 2, wherein the method further comprises:
determining a fault rate feature vector of the target gas meter based on the use data and the maintenance data when there is not the target replacement prediction model in the plurality of replacement prediction models, wherein the fault rate feature vector represents probabilities of failure of the target gas meter in different use cycles; and
determining the target time for replacing the target gas meter by processing the fault rate feature vector based on a target algorithm.

7. The method for gas meter replacement prompt based on a smart gas Internet of Things of claim 6, wherein the target algorithm includes a first preset algorithm and a second preset algorithm, and the determining the target time for replacing the target gas meter by processing the fault rate feature vector based on a target algorithm includes:
obtaining reference use data and reference maintenance data of a plurality of reference gas meters from the smart gas data center, and each of the plurality of reference gas meters corresponds to one of the plurality of replacement prediction models;
for each of the plurality of reference gas meters, determining a reference fault rate feature vector of the reference gas meter based on the reference use data and the reference maintenance data of the reference gas meter;
processing and analyzing the fault rate feature vector and a plurality of the reference fault rate feature vectors based on the first preset algorithm, and determining one or more target reference gas meters from the plurality of reference gas meters; and
determining the target time for replacing the target gas meter by processing the reference use data and the reference maintenance data of the one or more target reference gas meters as well as the use data and the maintenance data of the target gas meter based on the plurality of replacement prediction models and the second preset algorithm.

8. The method for gas meter replacement prompt based on a smart gas Internet of Things of claim 7, wherein the first preset algorithm is a clustering algorithm.

9. The method for gas meter replacement prompt based on a smart gas Internet of Things of claim 7, wherein determining the target time for replacing the target gas meter by processing the reference use data and the reference maintenance data of the one or more target reference gas meters as well as the use data and the maintenance data of the target gas meter based on the plurality of replacement prediction models and the second preset algorithm includes:
for each of the one or more target reference gas meters, determining a reference target time of the target reference gas meter by processing the reference use data and the reference maintenance data of the target reference gas meter based on the replacement prediction model corresponding to the target reference gas meter; and
determining the target time for replacing the target gas meter by analyzing the reference target time, the reference use data, and the reference maintenance data of each of the one or more target reference gas meters as well as the use data and the maintenance data of the target gas meter based on the second preset algorithm.

10. A system for gas meter replacement prompt based on a smart gas Internet of Things, the system including a smart gas user platform, a smart gas service platform, a management platform of a smart gas device, a smart gas sensor network platform and a smart gas object platform, and the management platform of the smart gas device including a sub platform of a management platform of a smart gas indoor device and a smart gas data center, wherein the sub platform of the management platform of a smart gas indoor device is configured to perform the following operations including:
obtaining model data, use data and maintenance data of a target gas meter in a smart gas data center;
determining a target time for replacing the target gas meter and uploading the target time to the smart gas data center based on the model data, use data and maintenance data of the target gas meter, wherein the smart gas data center is configured to send the target time to a smart gas service platform, and the smart gas service platform is configured to send the target time to a smart gas user platform.

11. The system for gas meter replacement prompt based on a smart gas Internet of Things of claim 10, wherein the sub platform of the management platform of a smart gas indoor device is configured to further perform the following operations including:
determining whether there is a target replacement prediction model in a plurality of replacement prediction models based on the model data, wherein the target replacement prediction model is a replacement prediction model applicable to the target gas meter in the plurality of replacement prediction models; and
determining the target time for replacing the target gas meter by the target replacement prediction model based on the use data and the maintenance data when there is the target replacement prediction model in the plurality of replacement prediction models.

12. The system for gas meter replacement prompt based on a smart gas Internet of Things of claim 11, wherein the plurality of replacement prediction models are machine learning models for predicting replacement times of gas meters, and each of the plurality of replacement prediction models is applicable to the gas meters of one model.

13. The system for gas meter replacement prompt based on a smart gas Internet of Things of claim 12, wherein the target replacement prediction model comprises an embedded layer and a target output layer, wherein
the embedded layer is configured to process the use data and the maintenance data of the target gas meter to obtain a use feature and a maintenance feature;
the target output layer is configured to process a model feature, the use feature, and the maintenance feature to obtain the target time for replacing the target gas meter.

14. The system for gas meter replacement prompt based on a smart gas Internet of Things of claim 13, wherein the embedded layer is shared by the plurality of replacement prediction models.

15. The system for gas meter replacement prompt based on a smart gas Internet of Things of claim 11, wherein the sub platform of the management platform of the smart gas indoor device is configured to further perform the following operations including:
determining a fault rate feature vector of the target gas meter based on the use data and the maintenance data when there is not the target replacement prediction model in the plurality of replacement prediction models, wherein the fault rate feature vector represents probabilities of failure of the target gas meter in different use cycles; and
determining the target time for replacing the target gas meter by processing the fault rate feature vector based on a target algorithm.

16. The system for gas meter replacement prompt based on a smart gas Internet of Things of claim 15, wherein the target algorithm includes a first preset algorithm and a second preset algorithm, and the determining the target time for replacing the target gas meter by processing the fault rate feature vector based on a target algorithm includes:
obtaining reference use data and reference maintenance data of a plurality of reference gas meters from the smart gas data center, and each of the plurality of reference gas meters corresponds to one of the plurality of replacement prediction models;
for each of the plurality of reference gas meters, determining a reference fault rate feature vector of the reference gas meter based on the reference use data and the reference maintenance data of the reference gas meter;
processing and analyzing the fault rate feature vector and a plurality of the reference fault rate feature vectors based on the first preset algorithm, and determining one or more target reference gas meters from the plurality of reference gas meters; and
determining the target time for replacing the target gas meter by processing the reference use data and the reference maintenance data of the one or more target reference gas meters as well as the use data, and the maintenance data of the target gas meter based on the plurality of replacement prediction models and the second preset algorithm.

17. The system for gas meter replacement prompt based on a smart gas Internet of Things of claim 16, wherein the first preset algorithm is a clustering algorithm.

18. The system for gas meter replacement prompt based on a smart gas Internet of Things of claim 16, wherein the sub platform of the management platform of the smart gas indoor device is configured to further perform the following operations including:
for each of the one or more target reference gas meters, determining a reference target time of the target reference gas meter by processing the reference use data and the reference maintenance data of the target reference gas meter based on the replacement prediction model corresponding to the target reference gas meter; and
determining the target time for replacing the target gas meter by analyzing the reference target time, the reference use data and the reference maintenance data of each of the one or more target reference gas meters as well as the use data and the maintenance data of the target gas meter based on the second preset algorithm.

19. A non-transitory computer-readable storage medium for storing computer instructions, wherein when the computer reads the computer instructions in the storage medium, the computer executes the method for gas meter replacement prompt based on a smart gas Internet of Things of claim 1.
